(19) United States
(12) Patent Application Publication
(10) Pub. No.: US 2004/0083145 A1
(43) Pub. Date: Apr. 29, 2004

(54) Method and system for processing tax reporting data

(76) Inventors: Susumu Kobayashi, Kawasaki (JP); Makoto Kitagawa, Fujisawa (JP); Toshiaki Tokunaga, Yokohama (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/439,109

(22) Filed: May 16, 2003

(30) Foreign Application Priority Data
Oct. 29, 2002 (JP) 2002-313759

(51) Int. Cl. G06F 17/60

(52) U.S. Cl. 705/31

(57) ABSTRACT

A system for processing tax reporting data, in which as soon as there occurs a taxable or deductible event, taxpayer identifying information for identifying a taxpayer, and listable transaction information as materials of tax reporting data are recorded, and reported to a tax data collecting portion to be thereby collected unitarily. Listable data such as taxables or deductibles, which will be materials of tax reporting data, is collected efficiently so that the burden in administration such as collection, recording, retention, and so on, of listable data imposed on interested parties of taxpayers can be lightened.

### BACKGROUND OF THE INVENTION

The present invention relates to a data processing method and system for producing tax reporting data in a tax return to be submitted to the tax authorities.

Electronic tax returns are coming into wide use in various countries. Electronic tax returns are expected to reduce the time and labor required for tax return procedures on taxpayers liable to taxation, or to reduce the cost due to paperless tax returns, or the like.

For example, a method for electronically collecting data about tax, producing tax reporting data and filing a tax return is disclosed in U.S. Pat. No. 6,202,052 “Fully-automated system for tax reporting, payment and refund”. According to this method, an “electronic intermediary” collects data from a “tax data provider” and produces tax reporting data.

In addition, a system for processing a final tax return in consideration of taxation of stock trading is disclosed in JP-A-2002-7710 “System and method for processing final tax returns”. According to this method, a tax amount on a taxable gross income and a tax amount on trading in stocks or the like are calculated, and tax withheld is subtracted from the tax amounts so that a final tax amount is calculated.

In the aforementioned US Patent in the related art, for example, bank statements (transaction particulars) are collected as information about tax. However, there is no consideration as to how to identify taxables in such a bank statement. That is, there is no consideration as to the contents of the statement and the way of recording in the statement for identifying information related to tax. It is therefore difficult to identify data related to tax on the basis of such information.

In addition, the bank statement does not always include particulars (breakdown) as materials of tax reporting data. For example, the statement does not always include requirements for filing a return of deduction for medical expenses, such as a person having taken medical treatment, the relationship of the person, and the address and name of a hospital/pharmacy. It is therefore difficult to automatically produce tax reporting data.

On the other hand, in the method of JP-A-2002-7710 in the related art, it is allowed to input information about trading in stocks in the form of a series of data from a securities company, but data about any other tax has to be input from a client system by a user.

Accordingly, taxpayers are heavily burdened for collecting and inputting data as materials of tax deduction or final returns. That is, for producing tax reporting data, taxpayers are heavily burdened in administration such as collection, input, recording and retention of data about tax as materials of tax reporting data.

In addition, it is difficult to identify listable data from a history etc. of transactions with a bank. Moreover, information as materials for producing tax reporting data is not included in such a history etc. Thus, tax reporting data cannot be produced.

### SUMMARY OF THE INVENTION

It is an object of the present invention to lighten taxpayer's burden in administration such as collection, input, recording and retention of data about tax in data processing for producing tax reporting data in tax returns to be submitted to tax authorities.

In order to attain the foregoing object, the present invention provides data processing for producing tax reporting data in a tax return to be submitted to a tax authority, by use of a listable transaction execution portion for making a listable transaction with a taxpayer liable to taxation, the listable transaction being a taxable or deductible transaction; a settlement portion for making settlement on the listable transaction; a tax data collecting portion for collecting the listable data about the listable transaction performed by the settlement portion; a taxpayer terminal portion for the taxpayer; a tax reporting data editing portion for calculating a tax amount based on the listable data collected by the tax data collecting portion, so as to produce tax reporting data; and a tax return portion for delivering the tax reporting data to a data processing portion of the tax authority to thereby file a tax return.

### BRIEF DESCRIPTION OF THE DRAWINGS

FIG. 1 shows a system configuration according to an embodiment of the present invention;

FIG. 2 shows a flow chart of processing in a preparatory phase in tax reporting data processing for an individual taxpayer;

FIG. 3 shows a flow chart of processing in a recording/collecting phase in the tax reporting data processing for an individual taxpayer;

FIG. 4 shows a flow chart of processing in a tax return phase in the tax reporting data processing for an individual taxpayer;

FIG. 5 is a data structure diagram of taxpayer data;

FIG. 6 is a data structure diagram of listable transaction information;

FIG. 7 shows an interface for confirming the contents of a year-end adjustment return of an individual taxpayer;

FIG. 8 shows an interface for confirming the contents of a final return of an individual taxpayer;

FIG. 9 shows a flow chart of processing for confirming the contents of a tax return by an individual taxpayer;

FIG. 10 shows a flow chart for processing monthly salary payment in data processing for withholding at source by a salary payer;

FIG. 11 shows a flow chart for processing year-end adjustment in the data processing for withholding at source by a salary payer; and

FIG. 12 shows a flow chart for issuing a notice of listable transaction information from a terminal of a taxpayer.

### DETAILED DESCRIPTION OF THE EMBODIMENTS

Embodiments of the present invention will be described below in detail with reference to the drawings.

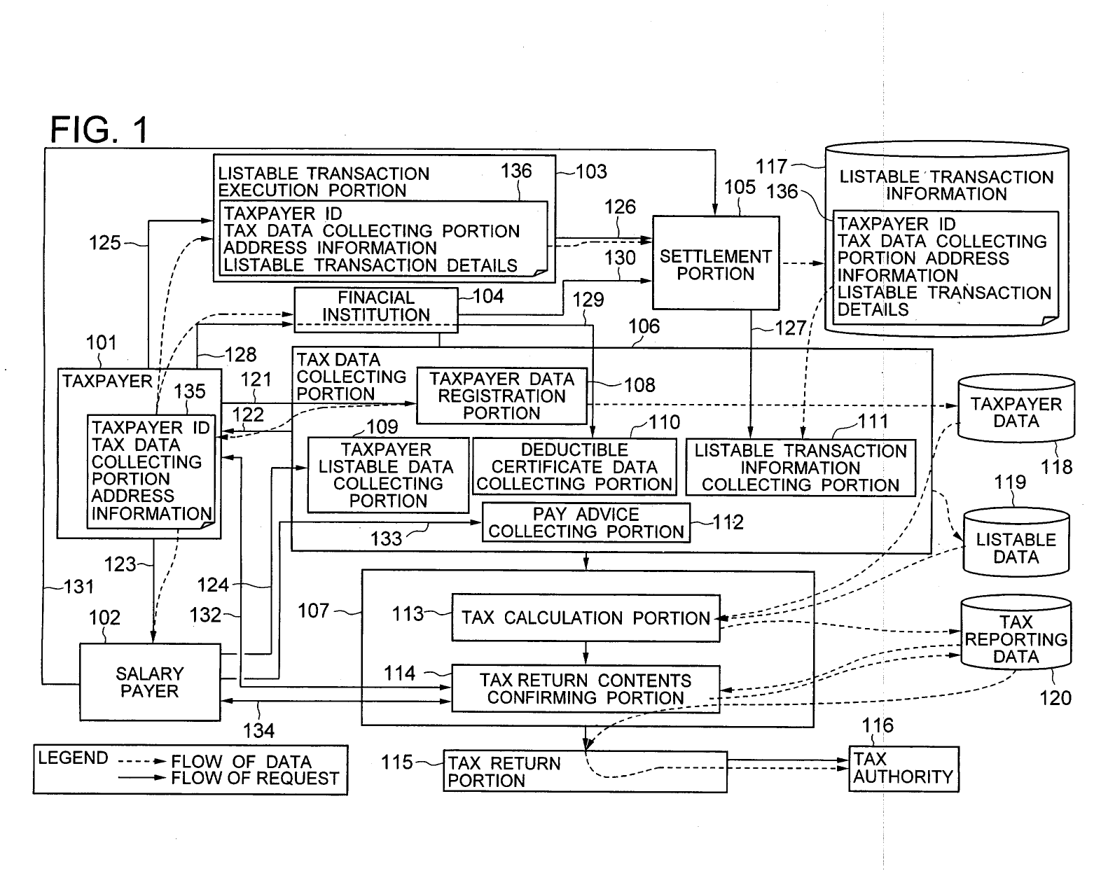

FIG. 1 shows the outline of the system configuration of an embodiment of the present invention. This system is a system provided to produce tax reporting data of a taxpayer and to submit a tax return to a tax authority. Further, this system is a system provided to collect taxable or deductible data required for producing the tax reporting data in place of the taxpayer, to calculate a tax amount and to produce the tax reporting data. In this embodiment, the taxpayer liable to taxation, for example, is an individual. The taxpayer receives a salary from a salary payer who pays salaries.

This system mainly comprises the following chief components.

A settlement portion 105 makes settlement about a listable transaction which will be taxable or deductible, and records listable transaction information 117 as materials of tax reporting data in the listable transaction in question. The settlement portion 105 is, for example, a computer system in a financial institution such as a bank where the taxpayer has an account.

Components for making listable transactions with a taxpayer terminal 101 include a listable transaction execution portion 103 (for example, a medical institution) for executing a transaction (for example, medical expense payment) which will be taxable or deductible, and a financial institution data processing portion 104 for providing financial services (for example, insurance, mortgage or securities) which will be taxable or deductible.

A tax data collecting portion 106 collects listable data 119 as materials of tax reporting data. The tax data collecting portion 106 comprises a taxpayer data registration portion 108 for registering and storing taxpayer data 118, a taxpayer listable data collecting portion 109, a deductible certificate data collecting portion 110 and a listable transaction information collecting portion 111. The portions 109-111 are provided correspondingly to respective kinds of listable data.

A tax reporting data editing portion 107 controls a tax calculation portion 113 and a tax return contents confirming portion 114 so as to calculate a tax amount and produce tax reporting data in place of the taxpayer. The tax calculation portion 113 calculates the tax amount on the basis of the taxpayer data 118 and the listable data 119. The tax return contents confirming portion 114 requests the taxpayer terminal 101 to confirm the contents of the tax reporting data produced by the tax calculation portion 113, and records the contents of the tax reporting data agreed by the taxpayer terminal 101 as tax reporting data 120.

A tax return portion 115 submits a tax return to the computer system (hereinafter referred to as “tax authority data processing portion”) 116 of a tax authority by use of the tax reporting data 120.

This system is a system comprised of computers and communication means such as the Internet. In addition, data processing in this system is attained by executing programs on the computers.

The following description shows the aforementioned components perform data processing. The data processing in each component is attained by executing a program on a computer corresponding to the component. The respective components give and receive data to and from each other as follows. The data is given and received through the communication means such as the Internet. These programs are stored in a computer-readable/writable storage medium such as a hard disk unit or a CD-ROM, which is accessible through the communication means such as the Internet.

The outline of the flow of tax reporting data processing in this system will be described below. Incidentally, the contents shown in the following embodiment discloses only chief ones of objects related to a tax return. In order to make description focus on the contents of the present invention, the details of the contents of listable data or other data that can be processed similarly will be omitted. Though not shown in the following embodiment, for example, the data that can be processed similarly includes special deduction from income authorized by a local government. Any illustrated object is not to limit the present invention to the following embodiments but is merely to facilitate understanding of the objects of the present invention.

Next, description will be made on processing for a year-end adjustment of withholding income tax payment and a final return of an individual taxpayer. The year-end adjustment is a procedure for adjusting the difference between the total amount of the income tax withheld for a year by a salary payer and the amount of the income tax which should be paid for the year.

The tax reporting data processing will be divided into the following four phases (stages) and described along the phases. (1) In a “preparatory phase”, information to be the key to recording and collection of the listable data is set. (2) In a “recording/collecting phase”, listable data is acquired, recorded and collected in the tax data collecting portion on the basis of the information set in the preparatory phase. (3) In a “tax reporting data producing phase”, tax amounts such as taxation amounts or deduction amounts are calculated on the basis of the collected listable data so that tax reporting data is produced. (4) In a “tax return phase”, a tax return is filed on the basis of the produced tax reporting data.

(1) First, in the preparatory phase, the following processing is carried out.

The taxpayer terminal 101 requests the tax data collecting portion 106 to collect listable data on behalf of the taxpayer (121). On this occasion, the taxpayer terminal 101 transmits personal attribute information (name, address, etc.) of the taxpayer to the tax data collecting portion 106.

In the tax data collecting portion 106, the taxpayer data registration portion 108 stores the received personal attribute information of the taxpayer in the taxpayer data 118. In response to the request from the taxpayer terminal 101, the tax data collecting portion 106 assigns a taxpayer ID to the taxpayer. The taxpayer ID is taxpayer identifying information for the taxpayer uniquely. Then, data 135 including the taxpayer ID and tax data collecting portion address information which is information for identifying the tax data collecting portion in the form of an address when data is delivered to the tax data collecting portion is delivered to the taxpayer terminal 101 (122).

The taxpayer terminal 101 holds the data 135 including the taxpayer ID and the tax data collecting portion address information received from the tax data collecting portion 106. This terminal may be, for example, an IC card, a portable telephone, a personal computer, or the like.

Next, the taxpayer terminal 101 requests the salary payer data processing portion 102 to deliver information (dependents and so on) about tax of the taxpayer to the tax data collecting portion 106 (123). On this occasion, the taxpayer terminal 101 delivers the data 135 including the taxpayer ID and the tax data collecting portion address information to the salary payer data processing portion 102.

The salary payer data processing portion 102 delivers the information about tax of the taxpayer to the tax data collecting portion 106 (taxpayer listable data collecting portion 109) on the basis of the tax data collecting portion address information (124).

In the tax data collecting portion 106, the information about tax of the taxpayer is registered in the taxpayer data 118 through the taxpayer data registration portion 108.

The processing so far belongs to the preparatory phase. Thus, the preparation for recording the listable data is complete.

(2) Next, the following processing is carried out in the recording/collecting phase. In this embodiment, the listable data to be recorded and collected includes (a) listable transactions such as medical expense payments or salary transfers, (b) carried insurances, and (c) mortgage loans.

(a) First, in a listable transaction, when the taxpayer terminal 101 makes a listable transaction with the listable transaction execution portion 103, the taxpayer terminal 101 delivers the data 135 including the taxpayer ID and the tax data collecting portion address information to the listable transaction execution portion 103 as a request to set the traction listable together with a request for settlement of the transaction (125).

In response to this request, the listable transaction execution portion 103 produces listable transaction particulars from the information about tax in the transaction. The listable transaction execution portion 103 transmits the listable transaction particulars and the data 135 including the taxpayer ID and the tax data collecting portion address information to the settlement portion 105 as listable transaction data 136 together with a request of settlement (126).

The settlement portion 105 performs settlement in response to the settlement request, and records the listable transaction data 136 in the listable transaction information 117. The settlement portion 105 transmits the listable transaction information 117 arranged for each taxpayer ID, to the tax data collecting portion 106 (listable transaction information collecting portion 111) on the basis of the tax data collecting portion address information (127).

In the tax data collecting portion 106, the listable transaction information is retained in the listable data 119.

Thus, the listable data of the listable transaction is recorded and collected.

Particularly, in salary transfer from the salary payer to the taxpayer, the salary payer data processing portion 102 makes a request to the settlement portion 105 for salary transfer (131). In response to this request, the salary payer data processing portion 102 establishes listable transaction particulars including the information about tax of the salary together with the data 135 including the taxpayer ID and the tax data collecting portion address information received from the taxpayer terminal 101, so as to form listable transaction data 136.

In the settlement portion 105, salary transfer is performed, and the listable transaction data 136 is recorded in the listable transaction information 117.

Subsequently, the tax data collecting portion 106 retains the listable transaction information in the listable data 119 in the same manner as above mentioned.

(b) The taxpayer terminal 101 delivers the data 135 including the taxpayer ID and the tax data collecting portion address information to the financial institution data processing portion 104 when the taxpayer takes out an insurance with the financial institution (128).

The financial institution data processing portion 104 produces insurance certificate data. The financial institution data processing portion 104 transmits the taxpayer ID of the taxpayer and the insurance certificate data to the tax data collecting portion 106 (deductible certificate data collecting portion 110) on the basis of the tax data collecting portion address information.

The tax data collecting portion 106 holds the insurance certificate data in the taxpayer data 118.

As for payment on an insurance premium made by the taxpayer, the financial institution data processing portion 104 requests the settlement portion 105 to collect the insurance premium (130). On this request, the financial institution data processing portion 104 establishes listable transaction particulars including information about tax of the insurance premium payment together with the data 135 including the taxpayer ID and the tax data collecting portion address information received from the taxpayer terminal 101, so as to form listable transaction data 136, when the taxpayer took out the insurance, as described above.

In the settlement portion 105, the insurance premium is collected, and the listable transaction data 136 is recorded in the listable transaction information 117.

Subsequently, the tax data collecting portion 106 retains the listable transaction information in the listable data 119 in the same manner as above mentioned.

(c) The taxpayer terminal 101 delivers the data 135 including the taxpayer ID and the tax data collecting portion address information to the financial institution data processing portion 104 when the taxpayer gets a mortgage from the financial institution.

The financial institution data processing portion 104 produces mortgage certificate data. The financial institution data processing portion 104 transmits the taxpayer ID of the taxpayer and the mortgage certificate data to the tax data collecting portion 106 (deductible certificate data collecting portion 110) on the basis of the tax data collecting portion address information.

The tax data collecting portion 106 holds the mortgage certificate data in the taxpayer data 118.

The processing so far belongs to the recording/collecting phase. Thus, the listable data 119 is recorded and collected.

(3) Next, the following processing is carried out in the tax reporting data producing phase.

The financial institution data processing portion 104 providing the mortgage transmits a year-end outstanding amount of the mortgage to the tax data collecting portion 106 at the time of year-end adjustment.

In the tax reporting data editing portion 107, a tax amount on the taxpayer is obtained by tax calculation based on the taxpayer data 118, the insurance certificate data, the mortgage certificate data, the year-end mortgage outstanding amount and the listable data 119 including the listable transaction information collected in the aforementioned manner.

First, a tax amount is obtained by trial calculation in the tax calculation portion 113, and the method for tax calculation is selected to correct the tax amount by application of taxation systems at that time, such that the taxpayer can get benefit from tax deduction systems. The tax calculation portion 113 performs tax calculation based on the selected tax calculation method so as to produce tax reporting data 120.

The tax return contents confirming portion 114 transmits the produced tax reporting data 120 to the taxpayer terminal 101 and requests the taxpayer terminal 101 to confirm the tax reporting data 120 (132). The taxpayer confirms the tax reporting data received by the taxpayer terminal 101. When the taxpayer approves the tax reporting data, the taxpayer attaches a signature to the tax reporting data through the taxpayer terminal 101. The taxpayer terminal 101 sends the signed tax reporting data back to the tax return contents confirming portion 114.

The tax reporting data editing portion 107 holds the data sent back from the taxpayer terminal 101, in the tax reporting data 120.

The processing so far belongs to the tax reporting data producing phase.

(4) Next, in the tax return phase, the tax return portion 115 sends the aforementioned tax reporting data 120 to the tax authority data processing portion 116 so as to file a tax return.

The processing so far corresponds to annual tax reporting data processing. In and after the following year, the taxpayer data set in the last year will be taken over, and the setting in the preparatory phase will be omitted. That is, the processing in and after the recording/collecting phase will be performed.

In such a manner, the following effect can be obtained by performing the tax reporting data processing according to the present invention.

According to the present invention, as soon as there occurs a listable transaction event, data about tax is extracted and acquired from information dealt with by interested parties such as the taxpayer or the listable transaction execution portion. Thus, the data about tax can be acquired neither too much nor too little, and processed efficiently.

In addition, according to the present invention, listable data is collected at any time from any place where the listable data has been recorded, in such a manner that the listable transaction information 117 in the settlement portion 105 is reported to the tax data collecting portion 106. Thus, the listable data can be collected efficiently even if an agent who is going to produce tax reporting data does not request the listable data himself/herself so as to collect the listable data. That is, the inventive manner can attain processing just enough and without concentrating loads on anywhere in comparison with the manner in which request for an annual transaction history including data irrelevant to tax are made on a large number of financial institutions at one time at the year end so as to collect the annual transaction history.

In addition, according to the present invention, all the data required for a year-end adjustment or a final return is collected in the tax data collecting portion 106, and tax reporting data is produced by the tax reporting data editing portion 107. As a result, for the year-end adjustment or the final return, the taxpayer only has to confirm the contents of the tax reporting data. Thus, the burden on the taxpayer can be lightened.

In addition, only the data about tax is reported from the data holding side to the tax data collecting portion 106. Thus, it is possible to avoid access to information irrelevant to tax, so that it is possible to make sure of security.

In addition, according to the present invention, the taxpayer ID is used to collect the listable data and produce the tax reporting data on behalf of the taxpayer. Thus, it becomes easy to identify the taxpayer, and the listable data can be separated for each taxpayer so that tax reporting data can be produced for each taxpayer.

In addition, according to the present invention, the listable data is reported from the settlement portion to the tax data collecting portion. Accordingly, either the taxpayer terminal or the listable transaction execution portion does not have to have communication means to the tax data collecting portion. Thus, the listable data can be collected on the basis of conventional data transmission/reception for settlement.

In addition, according to the present invention, with the tax data collecting portion address information, the tax data collecting portion used by each taxpayer can be specified even if there are a plurality of tax data collecting portions. That is, the number of agents who produce tax reporting data is not limited to one, but may be plural.

In addition, according to the present invention, in the tax reporting data editing portion 107, tax calculation is performed in place of the taxpayer. Thus, it becomes easy for the taxpayer to deal with a change of taxation systems, so that the burden on the taxpayer is lightened. That is, the taxpayer does not have to know the change of the systems or the details of tax calculation very well, but only has to confirm the result of calculation performed by the tax reporting data editing portion 107.

In addition, according to the present invention, the taxpayer terminal 101 delivers the data 135 including the taxpayer ID and the tax data collecting portion address information to thereby make a request for a notice of the taxpayer data from the salary payer data processing portion 102 to the tax data collecting portion 106, transmission of listable transaction information at the time of settlement, transmission of certificate data from the financial institution data processing portion 104, and so on. Thus, the taxpayer himself/herself sends a request for transferring data about tax.

As a result, the agreement of the taxpayer can be obtained about transmission of only necessary information for the sake of production of tax reporting data on behalf of the taxpayer. In addition, any entity transmitting/receiving the listable data is restricted to be prevented from using the listable data for any purpose other than the production of tax reporting data. Thus, arrangements are made to prevent private information from being applied to any other purpose.

The tax reporting data processing according to the present invention will be described below in more detail for each phase.

First, the processing for a year-end adjustment of withholding income tax payment and a final return of an individual taxpayer, which has been described above, will be described in more detail.

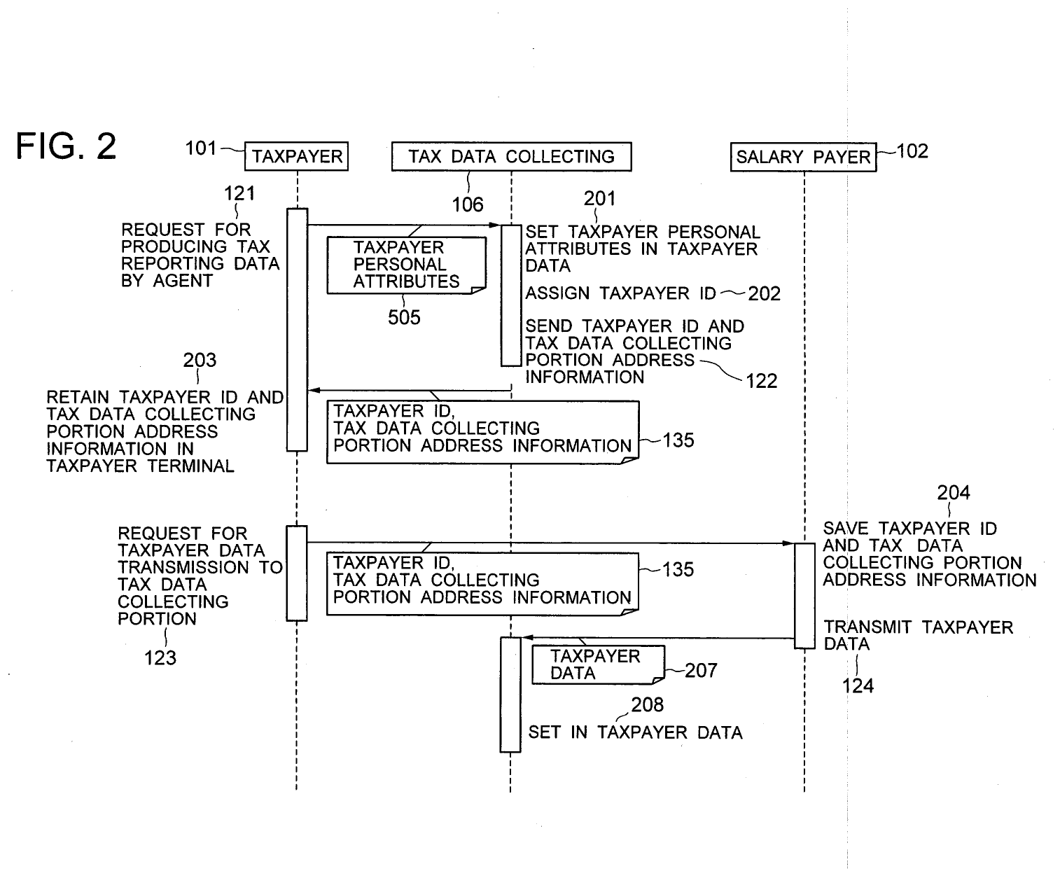

(1) FIG. 2 shows the details of processing in the preparatory phase.

The taxpayer terminal 101 requests the tax data collecting portion 106 to collect listable data on behalf of the taxpayer (121). On this occasion, the taxpayer terminal 101 transmits personal attribute information 505 of the taxpayer to the tax data collecting portion 106.

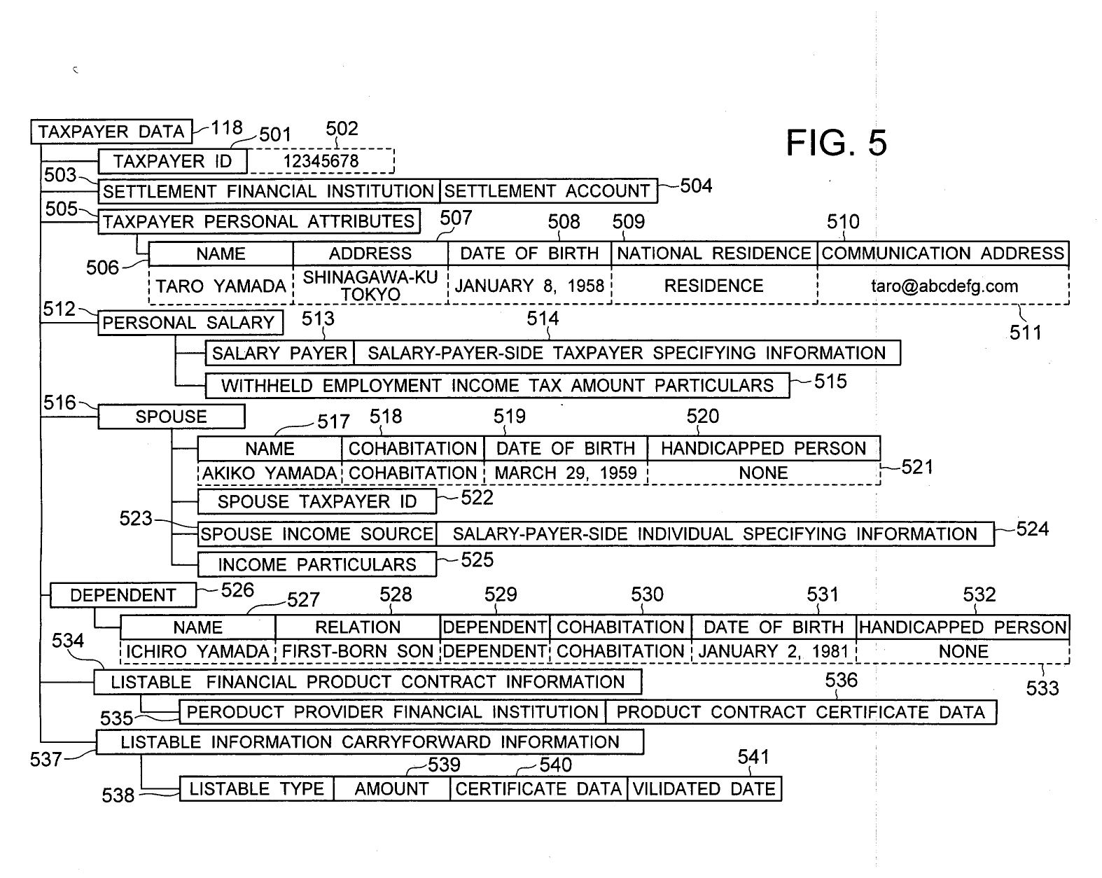

The personal attribute information 505 of the taxpayer includes values corresponding to items belonging to the taxpayer personal attribute information 505 shown in FIG. 5, comprised of a name item 506, an address item 507, a date of birth item 508, a national residence item 509, and a contact address item 510. Incidentally, the taxpayer personal attribute information 505 and the following data may be expressed by XML (eXtensible Markup Language). Private information can be protected by security measures such as encryption of XML elements or setting of access policy.

In the tax data collecting portion 106, the taxpayer data registration portion 108 sets the received personal attribute information 505 of the taxpayer in the taxpayer data 118 (201). In response to the request from the taxpayer terminal 101, the tax data collecting portion 106 assigns a taxpayer ID to the taxpayer (202). The taxpayer ID is taxpayer identifying information for identifying the taxpayer uniquely. Then, the taxpayer ID is delivered to the taxpayer terminal 101 together with tax data collecting portion address information, which is information for identifying the tax data collecting portion in the form of an address when data is delivered to the tax data collecting portion (122).

Incidentally, any information may be used as the taxpayer ID if it can identify each taxpayer uniquely in the tax data collecting portion 106. For example, the taxpayer ID may be a number easy for the taxpayer to check, such as “12345678” shown in the item 502 in FIG. 5, or may be binary data difficult to be appropriated. The taxpayer ID may be a unique number which has been used socially, such as a social security number in the United States. The taxpayer ID may be created on the basis of a value specified by the taxpayer terminal 101. Further, when an ID for identifying the tax data collecting portion 106 is included in the taxpayer ID as a prefix, the taxpayer can be specified by the taxpayer ID if there are a plurality of tax data collecting portions 106.

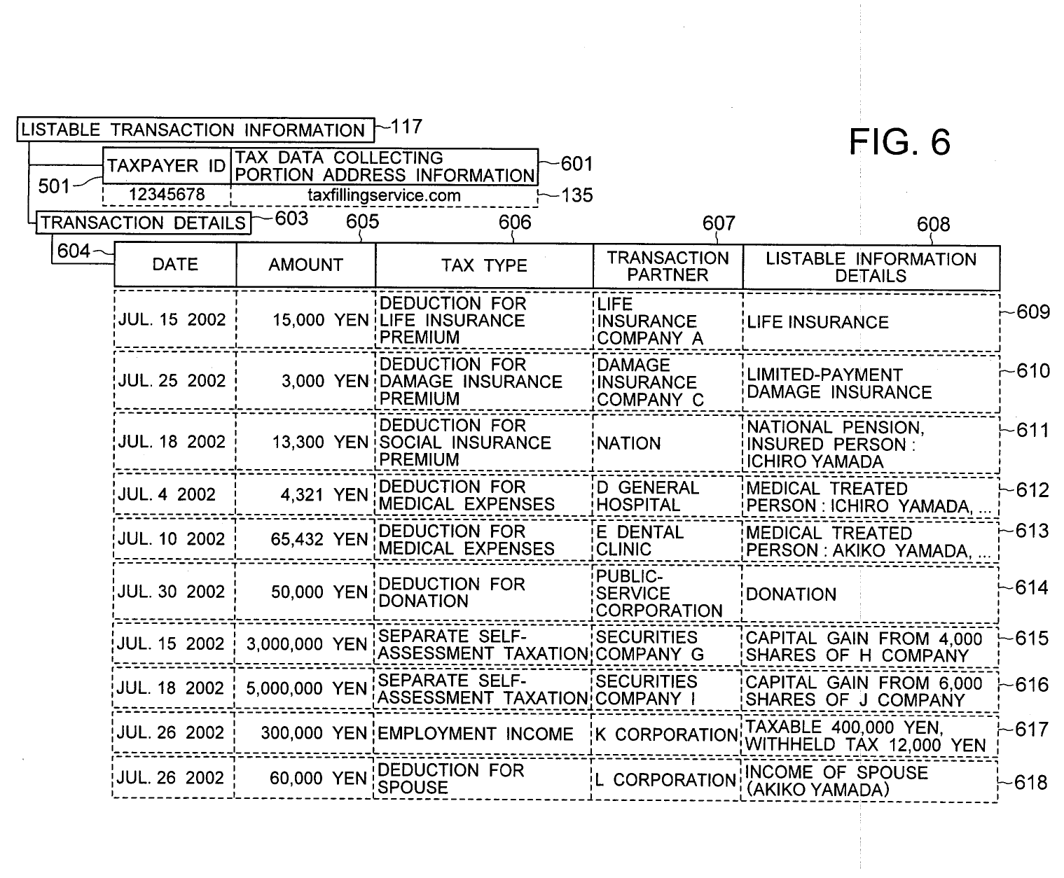

For example, the tax data collecting portion address information may be an address to be used for transmitting data via the Internet or a service name for calling a program, such as “taxfilingservice.com” shown in the data 135 present in the item 601 of the tax data collecting portion address information in FIG. 6.

The taxpayer terminal 101 holds the taxpayer ID and the tax data collecting portion address information received from the tax data collecting portion 106 (203). This taxpayer terminal 101 may be, for example, an IC card, a portable telephone, a personal computer, or the like.

Next, the taxpayer terminal 101 requests the salary payer data processing portion 102 to deliver information about tax of the taxpayer to the tax data collecting portion 106 (123). Together with this request, the taxpayer terminal 101 delivers the data 135 including the taxpayer ID and the tax data collecting portion address information to the salary payer data processing portion 102.

Here, the information 207 about tax of the taxpayer is comprised of the following items shown in FIG. 5, that is, a salary payer item 513 and a salary-payer-side taxpayer identifying information item 514 under a personal salary item 512; a name item 517, a cohabitation item 518, a date of birth item 519 and a handicapped person item 520 (a data example is shown in data 521) under a spouse item 516; a name item 527, a relation item 528, a dependent item 529, a cohabitation item 530, a date of birth item 531 and a handicapped person item 532 (a data example is shown in data 533) under a dependent family member item 526,

The salary payer data processing portion 102 retains information of the dependents and so on, for granting allowances or the like. The salary payer data processing portion 102 stores the data 135 including the taxpayer ID and the tax data collecting portion address information delivered from the taxpayer terminal 101 (204). For example, the salary payer data processing portion 102 stores the data 135 including the taxpayer ID and the tax data collecting portion address information in association with data retained for managing the taxpayer as an employee of a company of the salary payer.

The salary payer data processing portion 102 delivers the information 207 about tax of the taxpayer to the tax data collecting portion 106 (taxpayer listable data collecting portion 109) on the basis of the tax data collecting portion address information delivered from the taxpayer terminal 101 (124). In the tax data collecting portion 106, the information 207 about tax of the taxpayer is set in the taxpayer data 118 through the taxpayer data registration portion 108 (208).

The processing so far belongs to the preparatory phase. Thus, the preparation for recording the listable data is complete.

(2) Next, the following processing is carried out in the recording/collecting phase.

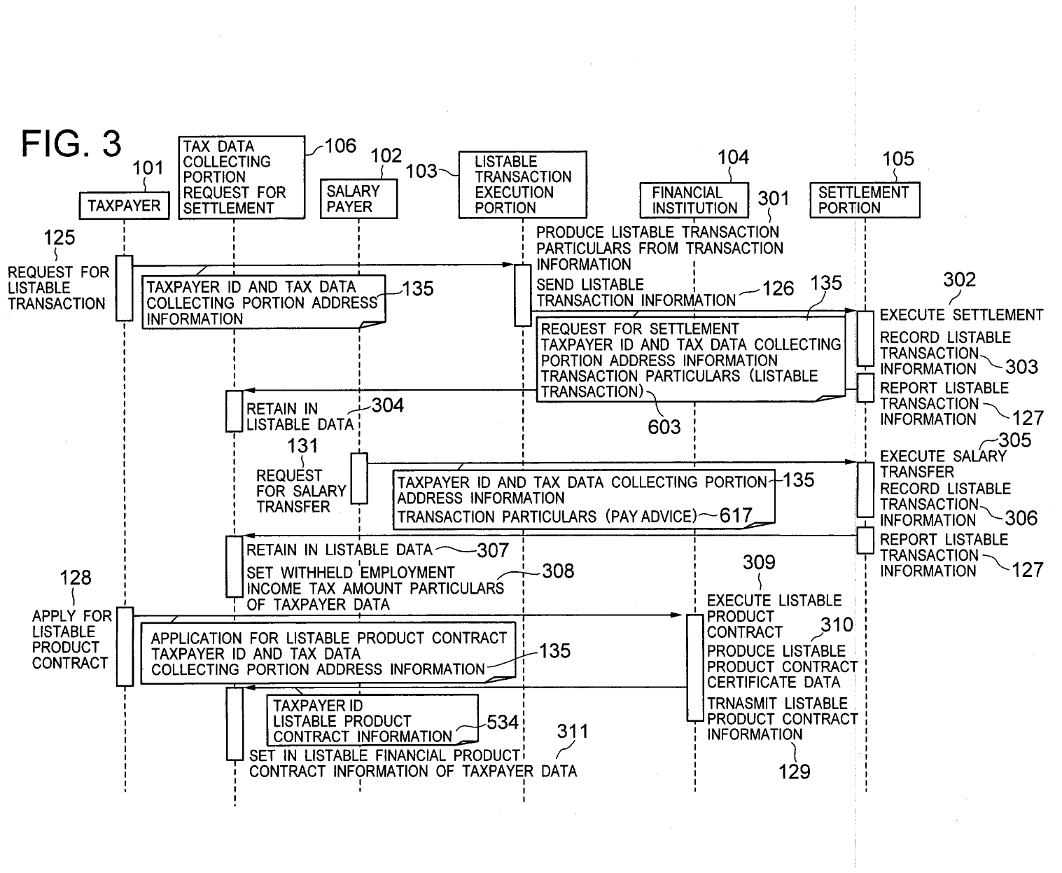

FIG. 3 shows the details of the processing in the recording/collecting phase.

In a listable transaction, when the taxpayer makes a listable transaction with the listable transaction execution portion 103, the taxpayer terminal 101 requests the listable transaction execution portion 103 to settle the listable transaction (125). Together with this request, the taxpayer terminal 101 delivers the data 135 including the taxpayer ID and the tax data collecting portion address information set for the taxpayer terminal 101.

In the case where the taxpayer terminal 101 has to assert the transaction to be listable when it makes a request for settlement of the transaction, for example, in the case where a transportation expense to a hospital listable as deduction for medical expense is set as the listable transaction, the taxpayer terminal 101 tells the listable transaction execution portion 103 (for example, transport facility) that the transportation expense should be set as listable in a tax return. For example, on the request for settlement of the transaction, the taxpayer terminal 101 delivers the data 135 including the taxpayer ID and the tax data collecting portion address information so as to identify the transaction as listable in a tax return. Thus, the listable transaction is specified explicitly so that listable data can be specified easily.

Incidentally, also when a family member (a family member within the same household, for example, the first-born son of the dependent family member in the data 533 in FIG. 5, Ichiro Yamada) pays a medical expense which is listable as deduction for medical expense, for example, the taxpayer ID of the householder (Taro Yamada) and the tax data collecting portion address information (“12345678”, “taxfilingservice.com”) are transmitted from the taxpayer terminal possessed by the family and used for settlement, in the same manner.

The taxpayer ID and the tax data collecting portion address information for the user himself/herself and those for the householder may be set separately in the taxpayer terminals possessed by the taxpayer and the family and used for settlement so that the taxpayer ID and the tax data collecting portion address information can be transmitted suitably in accordance with whether the listable transaction is for the individual taxpayer or for the family. As a result, the listable transaction information of the medical expense payments can be arranged with the taxpayer ID as a key, as will be described later. Thus, payments made on the family's medical expenses can be summed up so that the certificate and breakdown of the medical expense payments can be made up, and transactions listable as deduction for medical expenses can be specified.

Next, in the listable transaction execution portion 103, listable information details which are detailed data as materials for producing tax reporting data listable as taxable or deductible are produced from the transaction contents in the transaction in question (301). The listable information details are data corresponding to the items of listable information details 608 in FIG. 6. For example, the listable information details in data 611 are data showing information required for the breakdown of deductible medical expenses, such as “medical treated person” and so on.

In such a manner, according to the present invention, as soon as there occurs a listable event (listable transaction), listable data as materials for producing tax reporting data is recorded surely just enough by the interested party (the taxpayer terminal 101 or the listable transaction execution portion 103). Thus, for producing the tax reporting data, efficient data processing can be performed within the confines of only listable data. Incidentally, a signature of the listable transaction execution portion 103 or the like may be attached to the data of the listable information details 608. Thus, the listable data is formed as authentic data to be used as a certificate in a tax return.

Next, the listable transaction execution portion 103 transmits the data 135 including the taxpayer ID and the tax data collecting portion address information, and the listable transaction particulars 603 to the settlement portion 105 together with a request for settlement (126). The transaction particulars 603 are comprised of a date item 604, an amount item 605, a tax category item 606, a transaction partner item 607, and a listable information details item 608. Here, as the listable information details and so on are sent together with the request for settlement, the listable information can be sent without increasing the number of times of communication in a regular settlement.

In addition, as the data (deduction for medical expenses) in the tax category item 606 is retained, only data suitable for a tax return can be extracted and processed when tax reporting data is produced in the tax return. For example, since deductible medical expenses are listable in a final return, they are not regarded as listable in a year-end adjustment. At the time of a final return, the deductible medical expenses are extracted for producing data for the final return. In such a manner, data processing can be performed efficiently in accordance with the timing required for each tax return.

The settlement portion 105 performs settlement in response to the settlement request (302), and records the listable transaction information 117 (303). The settlement portion 105 transmits the listable transaction information 117 arranged for each taxpayer ID 501, to the tax data collecting portion 106 (listable transaction information collecting portion 111) on the basis of the tax data collecting portion address information 601 (127).

The tax data collecting portion 106 retains the listable transaction information in the listable data 119 (304). For example, transaction particulars 612 and 613 of medical expense payments, transaction particulars 614 of a donation and a payment 611 of a social insurance premium (national pension premium) are retained as shown in FIG. 6. In addition, transaction particulars 615 and 616 of stock transactions are also retained. When stock transactions in a plurality of financial institutions (a securities company G and a securities company I in the examples 615 and 616) are collected together in the tax data collecting portion 106 in such a manner, the balance of all the stock transactions of the taxpayer in question can be grasped.

In such a manner, listable data of listable transactions are recorded and collected. Specifically, the processing about listable data will be described below.

First, description will be made on recording income (employment income).

In salary transfer from the salary payer data processing portion 102 to the taxpayer, the salary payer data processing portion 102 makes a request to the settlement portion 105 for salary transfer (131). Together with this request, the salary payer data processing portion 102 establishes the data 135 including the taxpayer ID and the tax data collecting portion address information received from the taxpayer terminal 101, and the listable transaction detail data 617 including information about tax of the salary in question. The taxable amount, the withheld income tax amount, and so on, are set in the transaction details data 617.

In the settlement portion 105, salary transfer is performed (305), and the transaction details data 617 is recorded in the listable transaction information 117 (306).

Subsequently, in the same manner as above mentioned, the listable transaction information 117 is delivered from the settlement portion 105 to the tax data collecting portion 106, and the tax data collecting portion 106 retains the listable transaction information in the listable data 119 (307). In addition, the withheld income tax amount acquired from the transaction details 617 is retained in withheld employment income tax amount particulars 515 of the taxpayer data 118 (308).

Next, description will be made on a notice of certificate data of a carried insurance or a mortgage loan, that is, listable product contract certificate data.

When the taxpayer terminal 101 applies to the financial institution data processing portion 104 for a listable product contract (128), the taxpayer terminal 101 delivers the data 135 including the taxpayer ID and the tax data collecting portion address information to the financial institution data processing portion 104 together with the contents of an application for the listable product contract.

In response to the application, the financial institution data processing portion 104 executes the listable product contract (309). The financial institution data processing portion 104 produces listable product contract certificate data (310). Though not shown clearly in detail in this example, the contents of the listable product contract certificate data are required as the contents set to be submitted to the tax authorities due to the tax systems for filing a corresponding tax return. The financial institution data processing portion 104 transmits the taxpayer ID of the taxpayer and the listable product contract certificate data to the tax data collecting portion 106 (deductible certificate data collecting portion 110) on the basis of the tax data collecting portion address information (129).

In the tax data collecting portion 106, a product provider financial institution item 535 and product contract certificate data 536 are set in listable financial product contract information 534 of the taxpayer data 118 corresponding to the taxpayer on the basis of the taxpayer ID of the taxpayer and the listable product contract certificate data (311). Similarly, when the listable product contract is cancelled, information of canceling the listable product contract is transmitted from the financial institution data processing portion 104 to the tax data collecting portion 106 (deductible certificate data collecting portion 110) so that the corresponding product contract certificate data 536 is made invalid.

When the taxpayer pays an insurance premium, the financial institution data processing portion 104 requests the settlement portion 105 to collect the insurance premium in the same manner as in the case of the listable transaction (130) (similarly to 126). On this request, the financial institution data processing portion 104 establishes the data 135 including the taxpayer ID and the tax data collecting portion address information received from the taxpayer terminal 101, and listable transaction details including information about tax in the insurance premium payment, so as to form listable transaction data 136, when the taxpayer took out the insurance.

In the settlement portion 105, the insurance premium is collected (similarly to 302), and the listable transaction data 136 is recorded in the listable transaction information 117 (similarly to 303).

Subsequently, the tax data collecting portion 106 retains the listable transaction information in the listable data 119 in the same manner as above mentioned. For example, transaction details data 609 of life insurance premium payment and transaction details data 610 of limited-payment damage insurance premium payment shown in FIG. 6 are retained.

The processing so far belongs to the recording/collecting phase. Thus, listable data is recorded and collected.

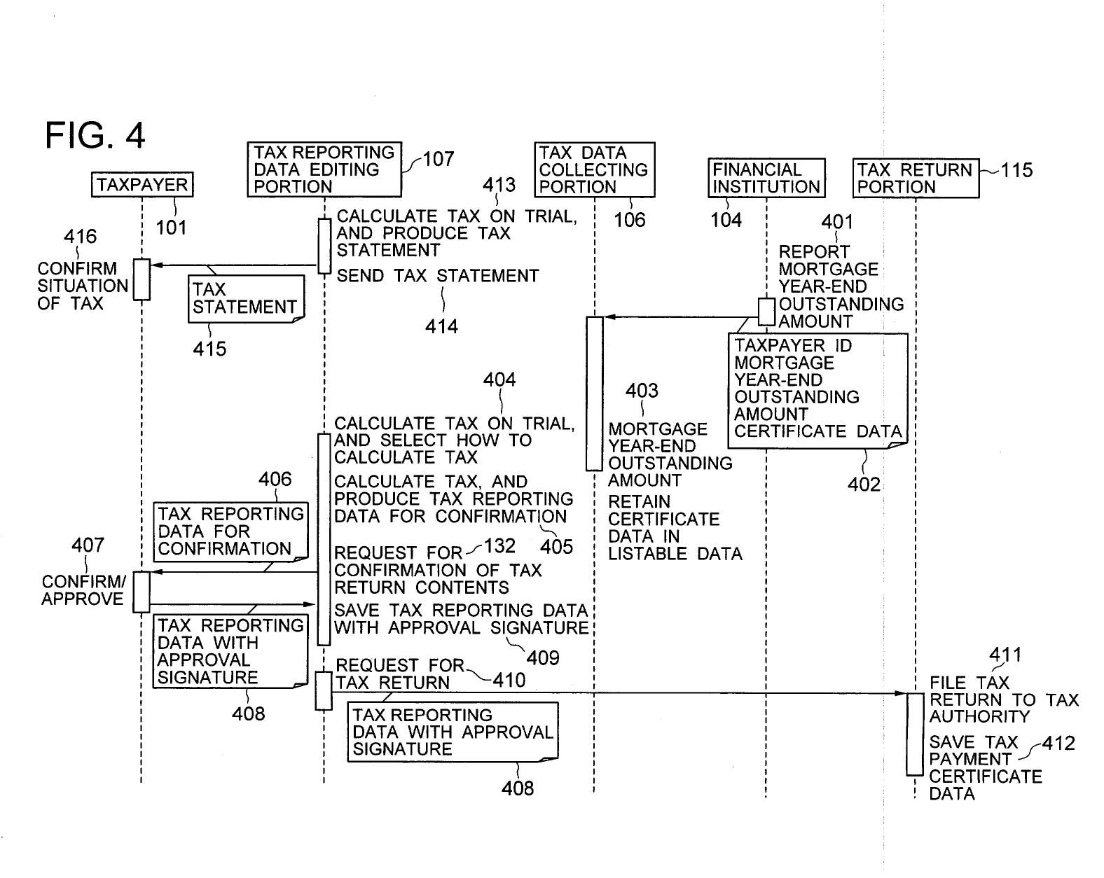

(3) Next, the following processing is carried out in the tax reporting data producing phase. FIG. 4 shows the details of the processing in the tax reporting data producing phase.

The financial institution data processing portion 104 providing a mortgage reports the taxpayer ID and mortgage year-end outstanding amount certificate data 402 to the tax data collecting portion 106 at the time of year-end adjustment (401). The mortgage year-end outstanding amount certificate data 402 certificates the outstanding amount of the mortgage of the taxpayer corresponding to the taxpayer ID. Here, the financial institution data processing portion 104 uses the taxpayer ID and the tax data collecting portion address information received at the time of the listable product contract. The contents of the mortgage year-end outstanding amount certificate data 402 are required as the contents set to be submitted to the tax authorities due to the tax systems for filing a corresponding tax return.

In the tax data collecting portion 106, the mortgage year-end outstanding amount certificate data is retained in the listable data 119 (403). On that occasion, the mortgage year-end outstanding amount certificate data of the taxpayer is arranged to be able to be specified in the listable data 119 with the taxpayer ID as a key.

Next, in the tax reporting data editing portion 107, a tax amount on the taxpayer is obtained by tax calculation based on the listable transaction information 117 retained in the taxpayer data 118 and the listable data 119 collected by the tax data collecting portion 106, and information required for tax amount calculation, such as the mortgage year-end outstanding amount, as described above.

First, a tax amount is obtained by trial calculation in the tax calculation portion 113, and the method of tax calculation is selected to correct the tax amount by application of taxation systems at that time, such that the taxpayer can get benefit from tax deduction systems (404). For example, it is judged whether the income is within the coverage of year-end adjustment or not. As a result, when, for example, the income exceeds 20,000,000 yen, it is out of year-end adjustment. In addition, for example, selected is the method for carrying forward a loss of trading in stocks or the method of tax calculation as to which taxpayer of family members within the same household should have a tax deduction for medical expenses or the like filed in his/her income tax. Thus, even if the taxpayer does not know the tax systems in question very well at the time of filing a tax return, the taxpayer can get benefit from tax deduction systems, so that the burden on the taxpayer for filing the tax return is lightened.

The tax calculation portion 113 performs tax calculation based on the selected tax calculation method so as to produce tax reporting data to be confirmed by the taxpayer (405). For example, the following processing is performed to obtain the amount of income of a spouse for deduction for the spouse.

When the spouse requests the tax data collecting portion 106 to collect listable data, the taxpayer ID item 522 of the spouse under the spouse item 516 of the taxpayer data 118 is acquired. By use of the taxpayer ID item 522 as a key, the withheld employment income tax amount particulars 515 are acquired from the personal salary item 512 of the taxpayer data 118 of the spouse. The amount of income of the spouse in question is acquired from the withheld employment income tax amount particulars 515.

When the spouse does not request the tax data collecting portion 106 to collect listable data, the income particulars of the spouse are produced on the basis of spouse income data 618 in the transaction details 603 retained in the listable data 119, and set in the income particulars item 525. Alternatively, the income particulars are acquired by an inquiry to the salary payer of the spouse on the basis of a spouse income source item 523 and a salary-payer-side individual identifying information item 524, and set in the income particulars item 525.

On the other hand, deduction for medical expenses is calculated as follows.

As described above, one of the family members within the same household records listable transaction information (transaction particulars 612 and 613 of medical expense payments) by use of a taxpayer ID of any one of the family members, such as the householder. Incidentally, when the spouse of the taxpayer in question records the listable transaction information 117 of the spouse through the tax data collecting portion 106, the transaction details of medical expense payments may be acquired from the listable transaction information of the spouse, so that the information of the medical expense payments of the spouse is added to and integrated with that of the taxpayer who should file a return of deduction for medical expenses. Thus, the transaction particulars of medical expense payments of the family members within the same household can be aggregated. Incidentally, since the income tax rate is progressive, the tax calculation portion 113 may selects, from the family members, a family member having the highest income as the taxpayer who should file a final return with deduction for medical expenses, so as to obtain the largest tax refund.

In addition, in the case of a balance carried forward, such as a loss of trading in stocks, a listable type item 538 (for example, trading in stocks), an amount item 539, a certificate data item 540 and a validated date item 541 (validated date by which the loss can be applied to a tax return) are retained in a listable information carryforward information item 537 in the taxpayer data 118.

Incidentally, the tax calculation portion 113 may be modularized for each category of taxation or deduction to be covered. For example, a calculation module for taxation on income due to trading in stocks may be present. Then, an entity for performing calculation may be selected for each modularized unit. For example, a securities company may include a calculation module for taxation on income due to trading in stocks. In that case, when calculation is performed, a result of tax calculation can be obtained by use of the taxation calculation of the securities company.

The entity for implementing the tax data collecting portion 106 may be separated from the entity for implementing the tax calculation portion 113. In this case, when there is a limit in entities allowed to perform tax calculation due to regulations or the like while there is no limit in entities collecting listable data, an entity such as a financial institution can collect listable data to be collected in the tax data collecting portion 106. Further, entities implementing the tax data collecting portion 106, the tax reporting data editing portion 107 and the tax return portion 115 may be selected suitably, respectively, in accordance with the situation of regulations or the like.

Next, description will be made on confirmation and approval of tax reporting data through the taxpayer terminal 101.

The tax return contents confirming portion 114 transmits the produced tax reporting data 406 for confirmation to the taxpayer terminal 101 and requests the taxpayer terminal 101 to confirm the tax reporting data 406 (132). The taxpayer terminal 101 confirms the received tax reporting data 406 for confirmation. When the taxpayer terminal 101 approves the tax reporting data 406, the taxpayer terminal 101 attaches an approval signature to the tax reporting data 406, and sends the signed tax reporting data 408 back to the tax return contents confirming portion 114 (407). In reply to this confirmation request 132, the taxpayer terminal 101 responds to the inquiry about whether the contents of the tax return should be corrected or agreed.

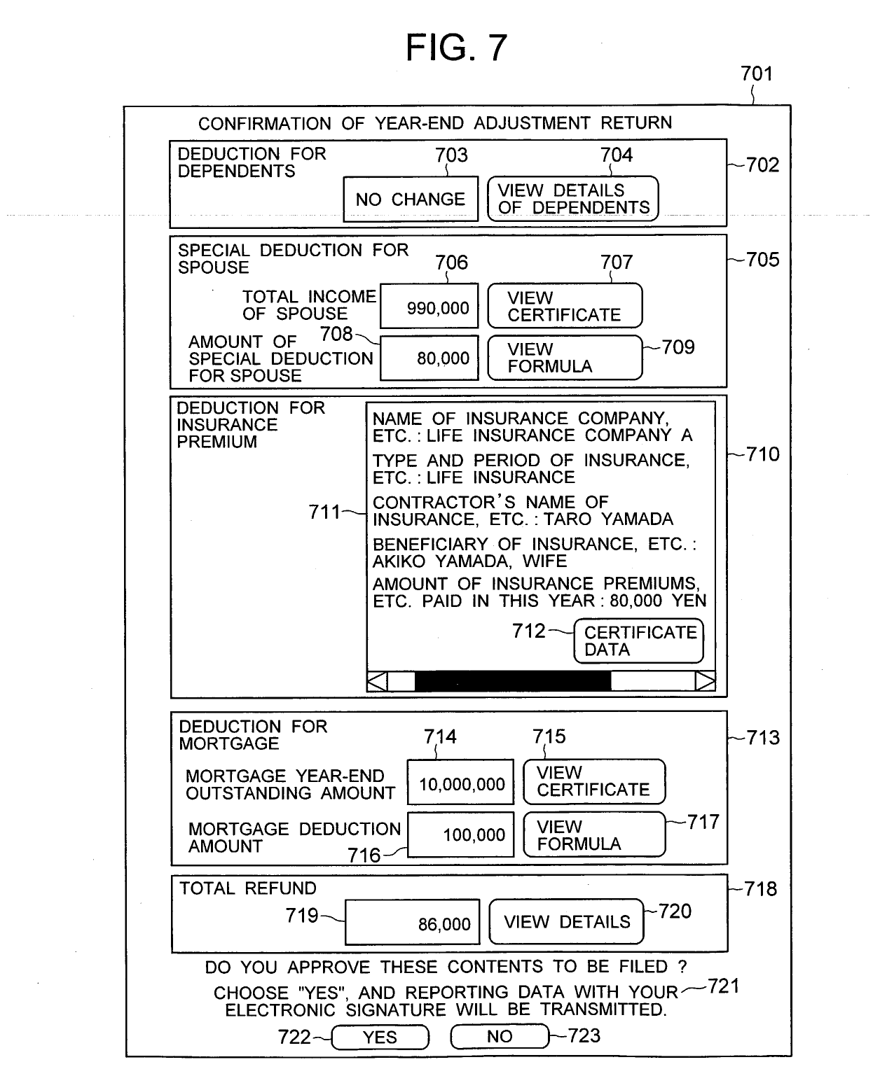

FIG. 7 shows an example of an interface to the taxpayer terminal 101 for confirming the contents of a year-end adjustment return. This interface is displayed on a display unit of a terminal such as a portable telephone or a personal computer, and various kinds of data are input through input means such as number keys of a portable telephone, a mouse, or a pointing device. Incidentally, this interface is provided to the taxpayer terminal 101 on the basis of the communication address item 510 under the taxpayer personal attribute item 505 of the taxpayer data 118.

A screen 701 for confirming the year-end adjustment return includes some fields as follows.

A field 702 showing the contents of deduction for dependents includes a display item 703 indicating a change of dependents in this year, and a button 704 for giving an instruction to display the details of the dependents when the taxpayer wants to confirm the details of the dependents.

A field 705 showing the contents of special deduction for spouse includes a display item 706 indicating a total amount of income of the spouse, a button 707 for giving an instruction to display a certificate of the amount of income when the taxpayer wants to confirm the certificate, a field 708 indicating a deduction amount claimable due to the special deduction for spouse, and a button 709 for giving an instruction to display a formula, by which the deduction amount was calculated, when the taxpayer wants to confirm the formula.

A field 710 showing the contents of deduction for insurance premiums includes a display item 711 indicating the contents of individual insurance premium payments, and a button 712 for giving an instruction to display certificate data of the insurance premium payments.

A field 713 showing the contents of deduction for mortgage includes a display item 714 indicating the year-end outstanding amount of the mortgage, a button 715 for giving an instruction to display a certificate of the outstanding amount, a field 716 indicating a deduction amount claimable due to the deduction for mortgage, and a button 717 for giving an instruction to display a formula, by which the deduction amount was calculated, when the taxpayer wants to confirm the formula.

A field 718 showing a total amount of refund claimable by the year-end adjustment includes a display item 719 indicating the amount of refund, and a button 720 for giving an instruction to display the details of calculation of the amount.

A message text 721 prompts the taxpayer to confirm whether a return having the above contents should be filed or not, and shows that an electronic signature of the taxpayer will be attached to the reporting data if the taxpayer approves the filing of the return. A button 722 for giving an instruction to give approval of the taxpayer to the reporting data, and a button 723 for giving an instruction to give no approval of the taxpayer to the reporting data and correct the reporting data are disposed under the message text 721.

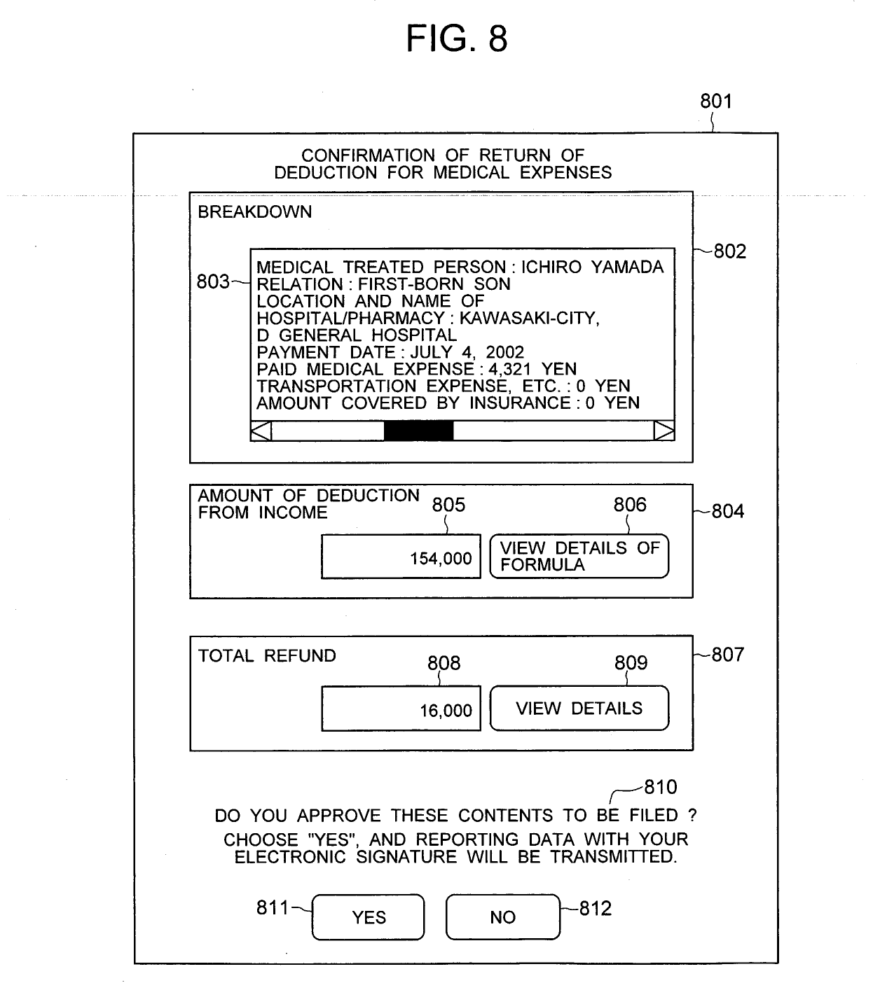

Next, FIG. 8 shows an example of an interface to the taxpayer terminal 101 for confirming a final return, particularly a return of deduction for medical expenses or the like. This interface is displayed on a display unit of a terminal such as a portable telephone or a personal computer, and various kinds of data are input through input means such as number keys of a portable telephone, a mouse, or a pointing device. Incidentally, this interface is provided to the taxpayer terminal 101 on the basis of the communication address item 510 under the taxpayer personal attribute item 505 of the taxpayer data 118.

A screen 801 for confirming a return of deduction for medical expenses includes some fields as follows.

A field 802 showing the breakdown of medical expense payments includes a display item 803 indicating the particular contents of individual medical expense payments.

A field 804 showing an amount to be deducted from income due to deduction for medical expenses includes a display item 805 indicating a deduction amount for income, and a button 806 for giving an instruction to display the details of calculation for the amount.

A field 807 showing a total amount of refund claimable by the deduction for medical expenses includes a display item 808 indicating the amount of refund, and a button 809 for giving an instruction to display the details of calculation for the amount.

A message text 810 prompts the taxpayer to confirm whether a return having the above contents should be filed or not, and shows that an electronic signature of the taxpayer will be attached to the reporting data if the taxpayer approves the filing of the return. A button 811 for giving an instruction to give approval of the taxpayer to the reporting data, and a button 812 for giving an instruction to give no approval of the taxpayer to the reporting data and correct the reporting data are disposed under the message text 810.

The contents of the interfaces for confirmation to the taxpayer shown in FIGS. 7 and 8 are created by the tax reporting data editing portion 107 which integrates, of the contents collected by the tax data collecting portion 106 as described previously, all the information about the year-end adjustment return of the taxpayer with the taxpayer ID as a key.

When such an interface showing such display items and details of tax calculation is presented to the taxpayer, the taxpayer can know the particular contents of the tax reporting data at the taxpayer's request even if the taxpayer does not know the tax systems or the method of tax calculation very well. In addition, the taxpayer can confirm the deduction amount at a glance. Thus, the burden on the taxpayer can be lightened. In addition, the taxpayer can file a year-end adjustment or a final return only if the taxpayer confirms the contents of the year-end adjustment or the final return and pushes the approval button. Thus, the burden on the taxpayer can be lightened.

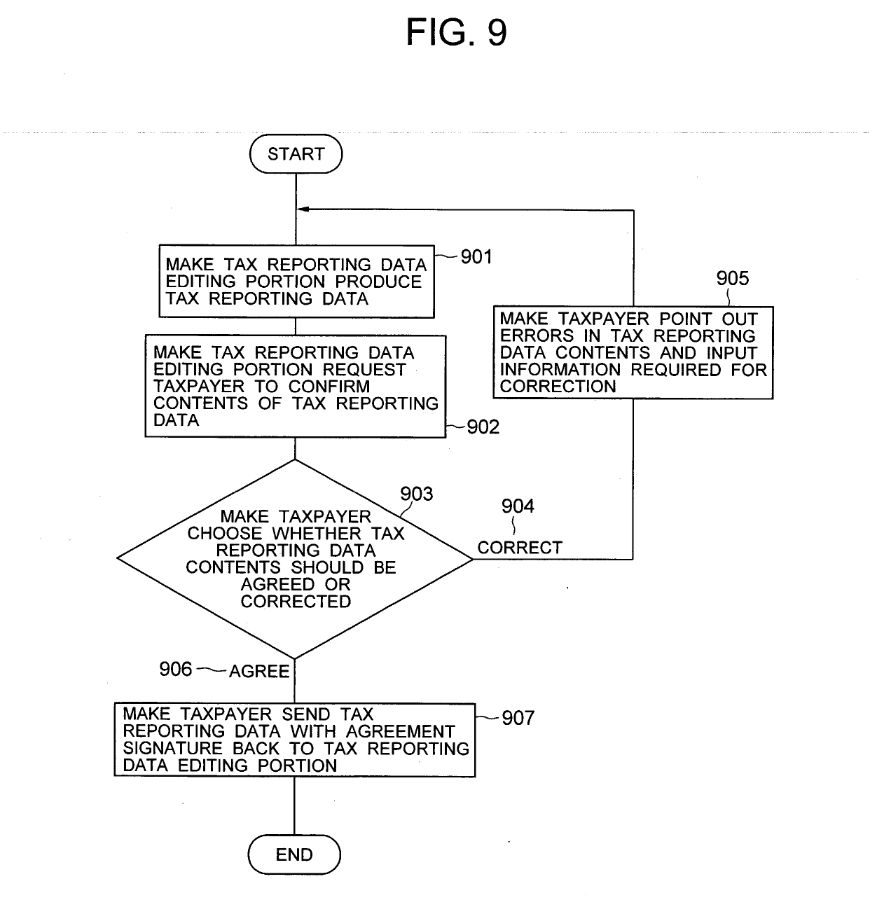

Next, FIG. 9 shows processing for allowing the taxpayer terminal 101 to confirm, approve or correct the contents of the tax reporting data.

First, the tax reporting data editing portion 107 creates tax reporting data as shown in Step 404 and Step 405 of FIG. 4 (901). Next, the tax reporting data editing portion 107 requests the taxpayer terminal 101 to confirm the contents of the tax reporting data as shown in Step 132 (902).

Next, the taxpayer terminal 101 chooses whether the taxpayer should approve or correct the tax reporting data contents for the tax return (903). When the taxpayer wants to correct the tax reporting data contents (904), the taxpayer terminal 101 presents errors in the tax reporting data contents, and information required for correction is input from the taxpayer terminal 101 (905). Then, the routine of processing returns to Step 901 in which tax reporting data reflecting the correction is produced. When the taxpayer approves the tax reporting data contents in the judgement of Step 903 (906), tax reporting data with an approval signature is created in the taxpayer terminal 101, and replied to the tax reporting data editing portion 107 (907).

The processing for allowing the taxpayer terminal 101 to confirm, approve or correct the contents of the tax reporting data is terminated thus. As a result of such processing, even when the taxpayer terminal 101 corrects the contents of a tax return, correct data for the tax return can be produced by inputting minimum information required for correction. Thus, the burden on the taxpayer can be lightened.

After that, the tax reporting data editing portion 107 saves the tax reporting data 408 with the taxpayer's approval signature sent back from the taxpayer terminal 101, in the tax reporting data 120 (409). As a result, when a tax authority makes a request for submission of the tax reporting data, this request can be met by extracting the saved tax reporting data 120.

The processing so far belongs to the tax reporting data producing phase.

(4) Next, in the tax return phase, the tax reporting data editing portion 107 delivers the tax reporting data 408 with the taxpayer's approval signature to the tax return portion 115 together with a tax return request 410 to the tax return portion 115.

The tax return portion 115 sends the tax reporting data to the tax authority data processing portion 116 so as to file a tax return (411). Here, when the tax return portion 115 acts for the taxpayer to file a tax return, the taxpayer terminal 101 may delegate the taxpayer's tax return authority (acting of certification) to the tax return portion 115. In addition, a taxpayer reference number or the like unique to each taxpayer and indicated by the tax authorities may be attached to the tax reporting data in accordance with necessity. In addition, a technique such as digital watermarking may be applied to the tax reporting data in order to check that the contents of the tax return has not been altered.

The tax return portion 115 receives tax payment certificate data from the tax authority data processing portion 116, and saves the tax payment certificate data (412). The taxpayer terminal 101 receives the tax payment certificate data from the tax return portion 115 in accordance with necessity. The tax payment certificate data may be sent from the tax return portion 115 to the taxpayer terminal 101 on the basis of the communication address 510 of the taxpayer terminal 101.

The processing so far corresponds to annual tax reporting data processing. In and after the following year, the taxpayer data 118 set in the last year will be taken over, and the setting in the preparatory phase will be omitted. That is, the processing in and after the recording/collecting phase will be performed. As a result, particularly when there is no change in dependents of the taxpayer or no change in signed insurance policies of the taxpayer, the taxpayer can file a year-end adjustment or a final return only if the taxpayer confirms the displayed contents in the interface shown in FIG. 7 or 8 and pushes the approval button. Thus, the burden on the taxpayer can be lightened.

An example in which the tax reporting data editing portion 107 carries out withholding data processing in place of the salary payer data processing portion 102 will be described below. A simple example will be shown, in which the taxpayer terminal 101 and the salary payer data processing portion 102 use one and the same tax reporting data editing portion 107. The overall system configuration is the same as that of FIG. 1.

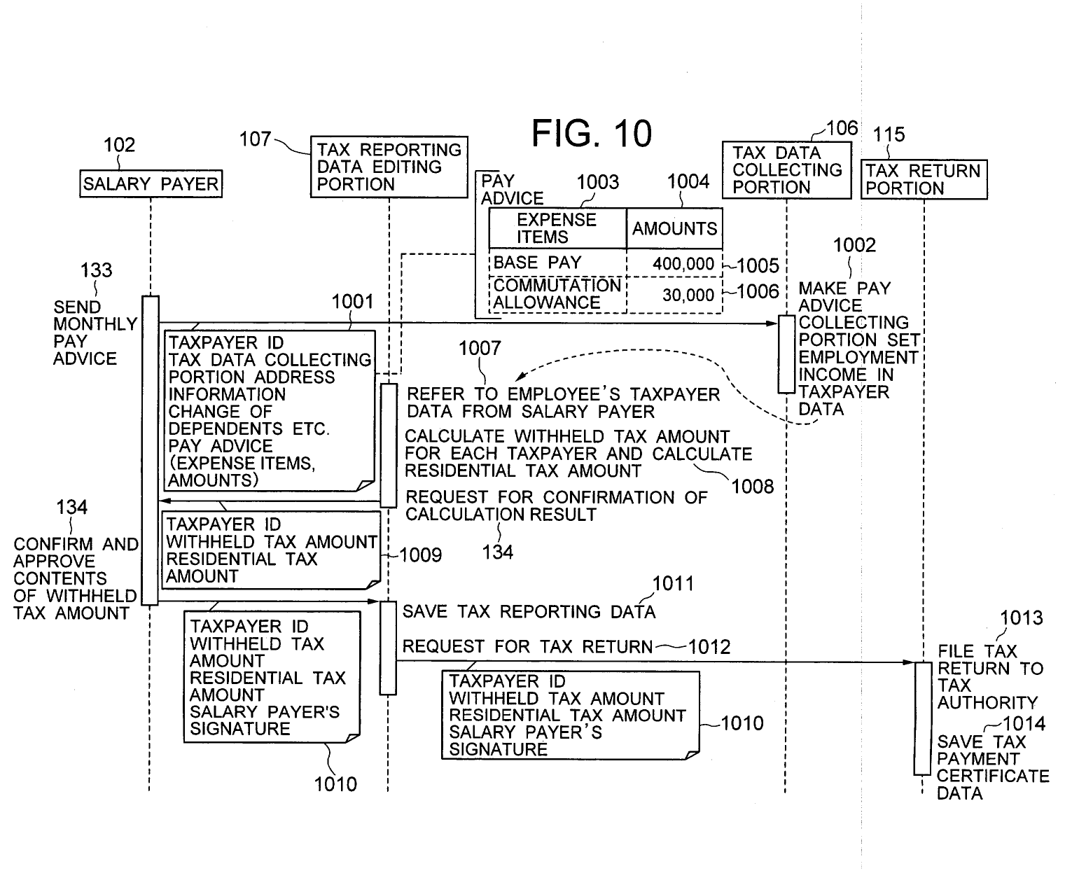

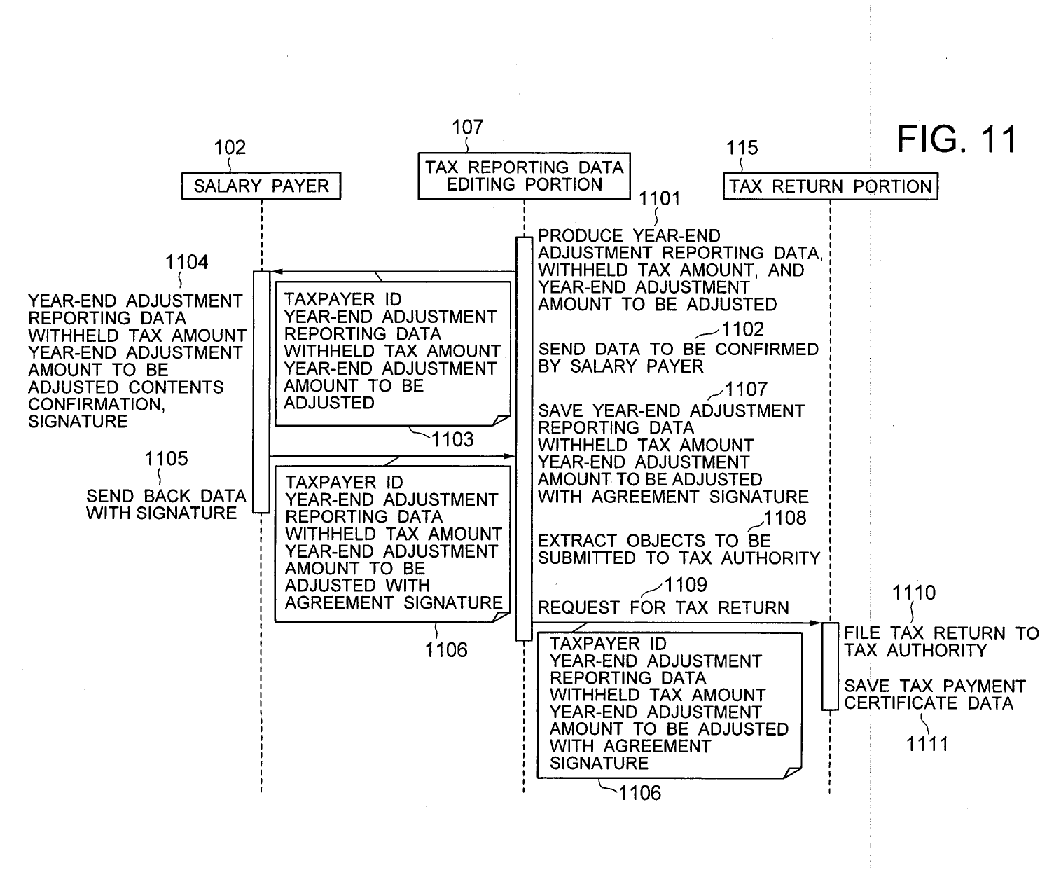

The acting of the withholding data processing for the salary payer data processing portion 102 is roughly divided into monthly salary payment and year-end adjustment. FIG. 10 shows the processing for the monthly salary payment, and FIG. 11 shows the processing for the year-end adjustment.

Assume that the salary payer data processing portion 102 entrusts data processing about withholding income tax payment to the tax reporting data editing portion 107. That is, the salary payer (company) terminal 102 commissions the tax reporting data editing portion 107 to perform data processing for withholding from salary paid to each taxpayer (employee).

The salary payer data processing portion 102 receives the data 135 including the taxpayer ID of the taxpayer in question and the tax data collecting portion address information from the taxpayer terminal 101 as shown in Step 123 of FIG. 1.

In addition, information required for fixing up the deduction amount for tax withheld such as a family allowance for the taxpayer and information (address, etc.) required for calculating a residential tax are transmitted to the tax data collecting portion 106 and set in the taxpayer data 118 as shown in Step 124 of FIG. 1.

In the data processing for withholding performed when monthly salary or a bonus is paid, first, data 1002 including a taxpayer ID, tax data collecting portion address information, a change of dependents or the like in this month, and a pay advice for each taxpayer, who is an employee, is delivered from the salary payer data processing portion 102 to the tax data collecting portion 106 (pay advice collecting portion 112) (133).

The pay advice is comprised of expense items 1003 to be used as criteria for judgment of taxables or deductibles, and amounts 1004. Examples of the data to be used as criteria for judgment in FIG. 10 include data 1005 indicating the amount whose expense item is a base pay and data 1006 indicating the amount whose expense item is a commutation allowance.

In the tax data collecting portion 106, the collected data 1002 such as a pay advice is set as a part of the withheld employment income tax amount particulars 515 in the taxpayer data 118 (1002).

Next, the tax reporting data editing portion 107 extracts the taxpayer data 118 having the corresponding salary payer in its salary payer item 513, refers to data set in the extracted taxpayer data 118 (1007), and uses the tax calculation portion 113 to calculate the deduction amount for tax withheld from the pay advice 515 of the taxpayer in question and to calculate the residential tax on the basis of the address item 507 (1008). The calculation result is data to be stored in items listed in a tax return or a format (for example, “register of withholding on employment income”, “accounting statement of amount of income tax such as employment income, retirement income, etc. (statement of payment)” or the like) to be submitted to the tax authorities.

The tax reporting data editing portion 107 sends the taxpayer ID and the aforementioned calculation result 1009 to the salary payer data processing portion 102, and requests the salary payer to confirm the contents of the calculation result 1009 (134). The salary payer confirms the calculation result data of the withheld tax amount received by the salary payer data processing portion 102, and replies to the tax reporting data editing portion 107 with the calculation result data to which the approval signature of the salary payer is attached by the salary payer data processing portion 102 (134).

The tax reporting data editing portion 107 saves the tax reporting data 1010 sent back from the salary payer data processing portion 102, in the tax reporting data 120 (1011). As a result, when there is a request to submit the tax reporting data to a tax authority, the saved tax reporting data 120 can be extracted to meet the request. Next, the tax reporting data editing portion 107 delivers the tax reporting data 1010 to the tax return portion 115 as a tax return request 1012.

The tax return portion 115 sends the tax reporting data to the tax authority data processing portion 116 so as to file a tax return (1013). When the tax return portion 115 acts for the salary payer to file the tax return, the salary payer data processing portion 102 may delegate the salary payer's tax return authority (acting of certification) to the tax return portion 115. In addition, a taxpayer reference number or the like unique to each salary payer and indicated by the tax authorities may be attached to the tax reporting data in accordance with necessity. In addition, a technique such as digital watermarking may be applied to the tax reporting data in order to check that the contents of the tax return has not been altered. The tax return portion 115 receives tax payment certificate data from the tax authority data processing portion 116, and saves the tax payment certificate data (1014). The salary payer data processing portion 102 receives the tax payment certificate data from the tax return portion 115 in accordance with necessity.

Next, the processing for the year-end adjustment will be described with reference to FIG. 11.

First, the tax reporting data editing portion 107 makes up a taxpayer ID, year-end adjustment reporting data, a withholding certificate, and a year-end adjustment amount 1103 for adjusting the overpaid amount or the underpaid amount of income tax for each taxpayer who is an employee (1101), and delivers them to the salary payer data processing portion 102 (1102). The year-end adjustment reporting data of the taxpayer is made up for the individual taxpayer as described in connection with the processing in FIG. 4 and the interface in FIG. 7. Incidentally, the year-end adjustment reporting data of the taxpayer extracted by use of the salary payer item 513 under the personal salary item 512 is delivered to the corresponding salary payer data processing portion 102. The salary payer data processing portion 102 specifies the taxpayer on the basis of the salary-payer-side taxpayer identifying information item 514.

The salary payer data processing portion 102 confirms the received contents and attaches the salary payer's approval signature thereto (1104), and replies to the tax reporting data editing portion 107 with the tax reporting data 1106 with the approval signature (1105).

The tax reporting data editing portion 107 retains the received tax reporting data (1107). Next, the tax reporting data editing portion 107 extracts objects to be listed in a tax return to the tax authorities (1108). For example, when the income is not more than 5,000,000 yen, it is not necessary to file a return to the tax authorities. Therefore, such a withholding certificate is excluded from the objects to be extracted here. Next, the tax reporting data editing portion 107 delivers the tax reporting data 1106 extracted in Step 1108 to the tax return portion 115 as a tax return request 1109.

The tax return portion 115 sends the tax reporting data to the tax authority data processing portion 116 so as to file a tax return (1110). The tax return portion 115 receives tax payment certificate data from the tax authority data processing portion 116 and saves the tax payment certificate data (1111).

The salary payer data processing portion 102 receives the tax payment certificate data from the tax return portion 115 in accordance with necessity.

In such a manner, data processing for income tax withholding is performed in place of the salary payer. Incidentally, although the withheld employment income tax amount particulars 515 of the taxpayer are set on the basis of a schedule of transactions about bank transfer in the aforementioned embodiment, the withheld employment income tax amount particulars 515 of the taxpayer may be set on the basis of the withheld tax amount made up in the withholding data processing of the salary payer data processing portion 102, as described above. Thus, the withheld employment income tax amount particulars 515 can be set without setting detailed items of expenses or amounts of money in a pay advice at the time of salary transfer.

Although the number “12345678” is shown as the taxpayer ID in the aforementioned embodiment by way of example, listable transaction information may be collected not using the taxpayer ID but using a settlement account number of the taxpayer in the settlement portion 105.

A settlement financial institution 503 and a settlement account 504 used by the taxpayer are set in the taxpayer data 118 in FIG. 5 in advance. In the settlement request 125 (FIG. 1) to the listable transaction execution portion 103, a request for settlement is made without setting the taxpayer ID. In addition, the taxpayer ID is not set in the Step 126 (FIG. 1), either.

In the listable transaction information 117, a settlement financial institution in the settlement portion 105 and a settlement account number of the taxpayer are set instead of the taxpayer ID. These are sent to the tax data collecting portion 106. The settlement financial institution 503 and the settlement account 504 in the taxpayer data 118 are checked with the settlement financial institution and the settlement account number of the taxpayer set in the listable transaction information 117 respectively. Thus, the taxpayer in question is specified, and the transaction particulars are retained in association with the taxpayer. In such a manner, it is not necessary to deliver the taxpayer ID to the listable transaction execution portion 103 and the settlement portion 105. As a result, it is possible to improve the security in comparison with that when the taxpayer ID is delivered. Further, the data quantity can be reduced so that the data processing can be made efficient.

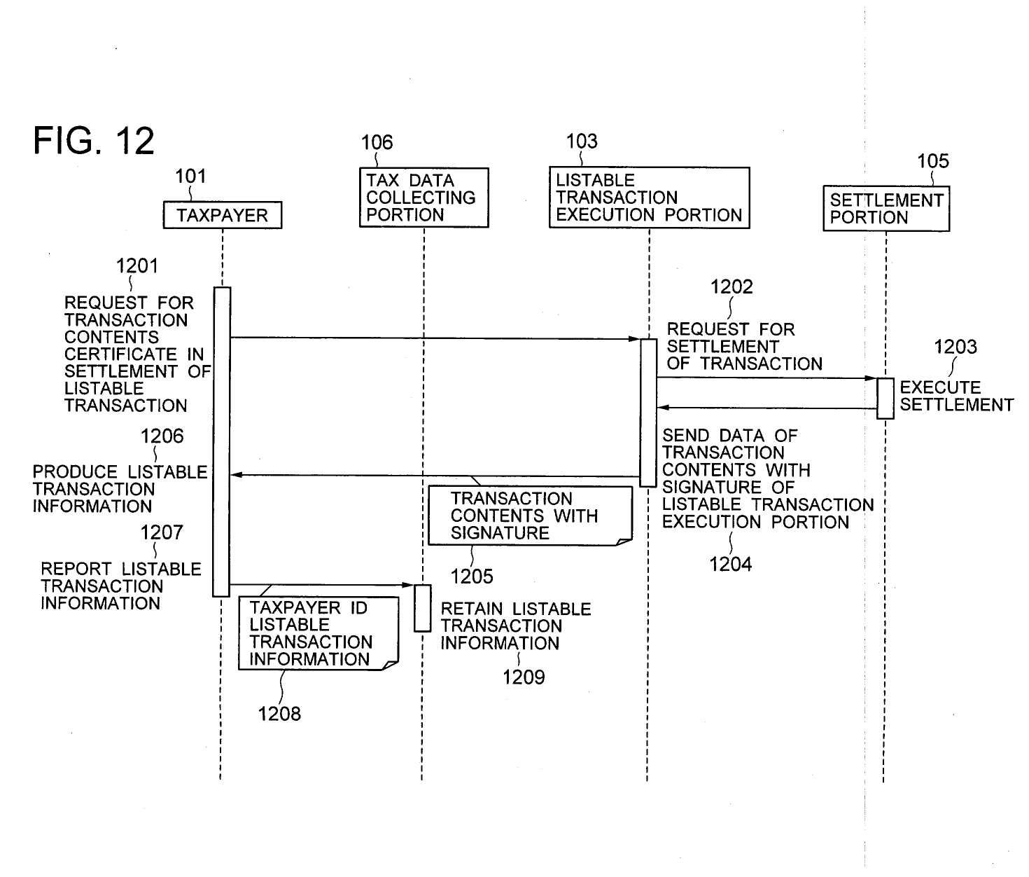

In addition, although the listable transaction information 117 is delivered to the tax data collecting portion 106 via the settlement portion 105 in the aforementioned embodiment by way of example, the listable transaction information 117 may be delivered to the tax data collecting portion 106 by means of the taxpayer terminal 101. The processing in this case will be described with reference to FIG. 12.

As soon as the taxpayer terminal 101 makes a request for settlement of a listable transaction with the listable transaction execution portion 103, the taxpayer terminal 101 makes a request for sending back a certificate of the transaction contents (1201).

The listable transaction execution portion 103 makes a request to the settlement portion 105 for settlement of the transaction (1202), and the settlement is carried out in the settlement portion 105 (1203). When the settlement is complete, the listable transaction execution portion 103 delivers transaction contents 1205, to which a signature of the listable transaction execution portion 103 is attached, to the taxpayer terminal 101 (1204).

In the taxpayer terminal 101, the listable transaction information 117 is produced on the basis of the transaction contents 1205 (1206). Data 1208 comprised of the taxpayer ID of the taxpayer and the listable transaction information is reported from the taxpayer terminal 101 to the tax data collecting portion 106 by use of the tax data collecting portion address information (1207). The tax data collecting portion 106 retains the listable transaction information (1209).

In such a manner, the listable transaction execution portion 103 or the settlement portion 105 does not have to include communication means to the tax data collecting portion 106. Thus, a system simpler than that in the aforementioned embodiment can be constructed. In addition, it is not necessary to send the details of the listable transaction at the settlement request 1202 from the listable transaction execution portion 103 to the settlement portion 105. It is therefore possible to reduce the data communication traffic in comparison with that in the aforementioned embodiment. In addition, it is possible to avoid the risk of information leakage of the listable transaction at the time of settlement.

It is not necessary to extract and produce the listable transaction information in the listable transaction execution portion 103. Thus, the system configuration of the listable transaction execution portion 103 can be made simpler. Incidentally, it is not necessary to choose only one of the notice of the listable transaction information from the taxpayer terminal 101 and the notice of the listable transaction information from the settlement portion 105. Both the notices may be used together only if the listable data 119 is collected unitarily in the tax data collecting portion 106.

The taxpayer may retain the listable transaction information in a portable terminal. Thus, the taxpayer can view data about tax without any inquiry to the tax data collecting portion 106. The listable transaction information may be used for creating an account book or the like in the taxpayer terminal 101.

In addition, advice information or guidance information about tax may be set in the taxpayer terminal 101. In this case, a listable transaction is instructed to the taxpayer terminal 101 on the listable transaction occasion 1201 on the basis of such information so that it is possible to assist the taxpayer terminal 101 to acquire the listable transaction information just enough.

Although the return contents of a year-end adjustment or a final return is confirmed at the time of filing in the aforementioned embodiment, the taxpayer may be made to confirm the return contents produced not at the time of filing but at any timing, for example, monthly. Such data for confirming the contents of a tax return is referred to as a tax statement.

FIG. 4 shows the processing for producing a tax statement.

The tax reporting data editing portion 107 does a trial tax calculation based on the taxpayer data 118 or the listable data 119, for example, monthly, and produces a tax statement 415 (413). Then, the tax reporting data editing portion 107 sends the tax statement 415 to the taxpayer terminal 101 on the basis of the communication address 510 of the taxpayer (414).

The taxpayer confirms the status of tax with reference to the tax statement 415 (416). The interfaces shown in FIGS. 7 and 8 may be used for confirmation in the taxpayer terminal 101 at this time. The taxpayer confirms the tax statement at any time before filing a tax return. Thus, the probability of occurrence of errors in the year-end adjustment or the final return can be lowered. The burden on the taxpayer confirming the one-year's contents at one time at the time of filing a tax return can be lightened. The amount of refund at the year end can be estimated with reference to the tax statement. In addition, the prospective as to whether deduction for medical expenses will be claimable or not can be obtained on the basis of the cumulative amount of medical expenses.

Incidentally, such a tax statement can be produced by use of listable data collected at any time by the tax data collecting portion 106 as described above. The listable data to be collected in the tax data collecting portion 106 may be not electronic data but conventional paper certificates. The listable data may be given countermeasures against alteration or the like, and then be converted into electronic data so that all the taxpayer terminals 101 can deal with the electronic data. Consequently, the labor for taxpayers to handle paper certificates can be saved. In addition, even if some certificates or the like are not issued electronically, it is possible to change over from an existing tax return to an electronic tax return easily.

The data structure of the taxpayer data in FIG. 5 will be described below. The respective items are just as already described for the processing flow or the like. With such a data structure, information required for calculation in tax deduction or the like can be retained.

When listable data is managed unitarily for each taxpayer by use of such a data structure, the listable data can be collected for each taxpayer to thereby make up tax reporting data.

In addition, by managing the listable data unitarily, it is possible to maintain the correctness simply and without omission of necessary items. Such data may be expressed in XML as described previously.

According to the present invention, the items of the taxpayer data are not limited to those in this embodiment. The data items can be changed suitably in accordance with a change of tax systems.

The data structure of the listable transaction information in FIG. 6 will be described below. The respective items are just as already described for the processing flow or the like.

With such a data structure, the information about listable transactions can be recorded just enough. In addition, listable data can be collected for each taxpayer to thereby make up tax reporting data. Such data may be expressed in XML as described previously. In this embodiment, only data of listable transactions in one month are shown for the sake of simplicity, but the data structure is not limited by time such as month or the like.

The aforementioned embodiment does not show specifically which entities implement the tax data collecting portion 106, the tax reporting data editing portion 107 and the tax return portion 115 respectively. However, these portions 106, 107 and 115 may be implemented in the taxpayer terminal 101. On this occasion, each taxpayer can protect listable data from information leakage under the taxpayer's own administration.

Alternatively, if there is no problem on regulations or the like, the financial institution data processing portion 104 may carry out the processing of the tax data collecting portion 106. The financial institution data processing portion 104 provides a surrogate service for collecting listable data, to taxpayers or salary payers. With such a configuration, the following business model can be attained. A financial institution obtains commission income in compensation for the surrogate service for tax reporting data processing.

In addition, financial products (insurance and mortgage) subject to the surrogate service are provided. When those products are purchased, the surrogate service can be obtained. Thus, the products are made more attractive, so that transactions with customers (taxpayers) can be expanded. Incidentally, when the financial institution data processing portion 104 having high publicity, high reliability and high data throughput carries out data processing for the surrogate service, the reliability of data can be secured.

When any financial institution is not allowed to produce tax reporting data or file tax returns in place of taxpayers due to regulations or the like, the tax reporting data editing portion 107 and the tax return portion 115 may be separated, while the taxpayer terminal 101 or the salary payer data processing portion 102 carries out the processing corresponding to these portions. Alternatively, when an entity, for example, a tax attorney is allowed to carry out the processing corresponding to the portions, the tax attorney may carry out the processing corresponding to the portions in place of taxpayers.

If there is no problem on regulations or the like, the financial institution data processing portion 104 may carry out a series of processing from collecting listable data to filing a tax return in place of a taxpayer. In addition, a financial institution may be entrusted with not only the tax reporting data processing but also the data processing such as salary calculation or information administration of dependents or the like in a lump from a salary payer.

A financial institution may provide a service of sending an aforementioned tax statement to each customer in the same manner as a statement listing transaction particulars. Each taxpayer or each salary payer can save the labor for filing a tax return by use of the surrogate service for the tax reporting data processing provided by the financial institution. Thus, the burden on the taxpayer or the salary payer can be lightened.

According to the present invention, in the method for processing tax reporting data, the burden on a taxpayer as to the production of the tax reporting data can be lightened, and the collection of listable data for producing the tax reporting data can be made efficient.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method for processing tax reporting data to thereby produce tax reporting data in a tax return to be submitted to a tax authority, comprising the steps of:
delivering taxpayer identifying information and tax data collecting portion address information from a taxpayer terminal portion to a listable transaction execution portion when a taxpayer makes a listable transaction which will be a taxable or deductible transaction, said taxpayer identifying information identifying said taxpayer, said tax data collecting portion address information being address information to a tax data collecting portion provided for collecting listable data as materials for producing tax reporting data of said taxpayer and as to said listable transaction performed in a settlement portion provided for making settlement about said listable transaction, said listable transaction execution portion executing said listable transaction with said taxpayer liable to taxation;
delivering said taxpayer identifying information, said tax data collecting portion address information, and said listable data including information about taxation or deduction as to said listable transaction, from said listable transaction execution portion to said settlement portion for making settlement when settlement is made on said listable transaction; and
delivering said taxpayer identifying information and said listable data from said settlement portion to said tax data collecting portion suggested by said tax data collecting portion address information, based on said tax data collecting portion address information.

2. A method for processing tax reporting data to thereby produce tax reporting data in a tax return to be submitted to a tax authority, comprising the steps of:
making a taxpayer terminal portion acquire listable data from a listable transaction execution portion when a taxpayer liable to taxation makes a listable transaction with said listable transaction execution portion, said transaction being a taxable or deductible transaction, said listable data including information about taxation or deduction about said listable transaction; and
making said taxpayer terminal portion deliver taxpayer identifying information and listable data to a tax data collecting portion based on tax data collecting portion address information, said taxpayer identifying information identifying said taxpayer, said tax data collecting portion address information being address information to said tax data collecting portion, said tax data collecting portion collecting said listable data as materials for producing tax reporting data of said taxpayer and as to said listable transaction performed in said listable transaction execution portion.

3. A method for processing tax reporting data according to claim 1, further comprising the steps of:
delivering tax reporting data of said taxpayer from a tax reporting data editing portion to said taxpayer terminal portion, said tax reporting data being made up by said tax reporting data editing portion calculating a tax amount based on said listable data collected by said tax data collecting portion;
delivering said tax reporting data with a signature of said taxpayer from said taxpayer terminal portion to a tax return portion for delivering said tax reporting data to a data processing portion of said tax authority to thereby file a tax return when said taxpayer gives an instruction to attach said signature of approval to said tax reporting data; and
delivering said tax reporting data with said signature of said taxpayer from said tax return portion to said data processing portion of said tax authority.

4. A system for processing tax reporting data to thereby produce tax reporting data in a tax return to be submitted to a tax authority, comprising:
a listable transaction execution portion for making a listable transaction with a taxpayer liable to taxation, said listable transaction being a taxable or deductible transaction;
a settlement portion for making settlement on said listable transaction;
a tax data collecting portion for collecting said listable data about said listable transaction performed in said settlement portion; and
a taxpayer terminal portion for said taxpayer;
wherein said taxpayer terminal portion includes means for delivering taxpayer identifying information and tax data collecting portion address information to said listable transaction execution portion provided for executing said listable transaction, said taxpayer identifying information identifying said taxpayer, said tax data collecting portion address information being address information to said tax data collecting portion provided for collecting said listable data as materials for producing tax reporting data of said taxpayer;
wherein said listable transaction execution portion includes means for delivering said taxpayer identifying information, said tax data collecting portion address information, and said listable data including information about taxation or deduction as to said listable transaction, to said settlement portion for making settlement, when settlement is made on said listable transaction; and
wherein said settlement portion includes means for delivering said taxpayer identifying information and said listable data to said tax data collecting portion suggested by said tax data collecting portion address information, based on said tax data collecting portion address information.

5. A system for processing tax reporting data to thereby produce tax reporting data in a tax return to be submitted to a tax authority, comprising:
a listable transaction execution portion for making a listable transaction with a taxpayer liable to taxation, said listable transaction being a taxable or deductible transaction;
a tax data collecting portion for collecting listable data about said listable transaction in said listable transaction execution portion; and
a taxpayer terminal portion for said taxpayer;
wherein said taxpayer terminal portion includes means for acquiring said listable data including information about taxation or deduction about said listable transaction from said listable transaction execution portion when said taxpayer makes said listable transaction with said listable transaction execution portion, and means for delivering taxpayer identifying information and said listable data to said tax data collecting portion based on tax data collecting portion address information, said taxpayer identifying information identifying said taxpayer, said tax data collecting portion address information being address information to said tax data collecting portion, said tax data collecting portion collecting said listable data as materials for producing tax reporting data of said taxpayer.

6. A system for processing tax reporting data according to claim 4, further comprising:
a tax reporting data editing portion for calculating a tax amount based on said listable data collected by said tax data collecting portion so as to produce tax reporting data; and
a tax return portion for delivering said tax reporting data to a data processing portion of said tax authority to thereby file a tax return;
wherein said tax reporting data editing portion includes means for producing said tax reporting data of said taxpayer based on said listable data, and delivering said tax reporting data to said taxpayer terminal portion;
wherein said taxpayer terminal portion includes means for delivering said tax reporting data with a signature of said taxpayer to said tax return portion when said taxpayer gives an instruction to attach said signature of approval to said tax reporting data; and
wherein said tax return portion includes means for delivering said tax reporting data with said signature of said taxpayer to said data processing portion of said tax authority.

7. A system for processing tax reporting data to thereby produce tax reporting data in a tax return to be submitted to a tax authority, comprising:
a listable transaction execution portion for making a listable transaction with a taxpayer liable to taxation, said listable transaction being a taxable or deductible transaction;
a settlement portion for making settlement on said listable transaction;
a tax data collecting portion for collecting said listable data about said listable transaction performed by said settlement portion;
a taxpayer terminal portion for said taxpayer;
a tax reporting data editing portion for calculating a tax amount based on said listable data collected by said tax data collecting portion, so as to produce tax reporting data; and
a tax return portion for delivering said tax reporting data to a data processing portion of said tax authority to thereby file a tax return.
